(19) United States
(12) Patent Application Publication
(10) Pub. No.: US 2014/0149785 A1
(43) Pub. Date: May 29, 2014

(54) DISTRIBUTED MANAGEMENT

(71) Applicants: M. Scott Bunker, Tomball, TX (US); Michael White, Houston, TX (US); Timothy A. McCree, Spring, TX (US)

(72) Inventors: M. Scott Bunker, Tomball, TX (US); Michael White, Houston, TX (US); Timothy A. McCree, Spring, TX (US)

(21) Appl. No.: 14/233,407

(22) PCT Filed: Oct. 25, 2011
(86) PCT No.: PCT/US2011/057625

§ 371 Date: Jan. 17, 2014

(51) Int. Cl. G05B 15/02; G06F 11/20

(52) U.S. Cl. CPC G05B 15/02; G06F 11/2089
USPC 714/6.2; 700/275

(57) ABSTRACT

A distributed management system comprises a backplane and a plurality drive assemblies communicatively coupled to the backplane via a communication channel. Each of the plurality of drive assemblies includes a computing device, and each of the computing devices is to provide drive environmental data and control a light source.

### BACKGROUND

Today's storage demands have created a need for systems that can store a massive amount of data. To this end, storage chassis have been developed to accommodate a plurality of drive assemblies. Each of the plurality of drive assemblies typically comprises a drive such as a hard disk drive (HDD) disposed within a drive carrier. The drive carrier is generally a mechanical device that serves to lock and hold the drive in a particular position within the storage chassis, and to protect the drive from electromagnetic energy interference (EMI) which may be caused by neighboring drives.

Each drive assembly is typically plugged into a portion of the storage chassis known as the backplane. The backplane typically comprises serial attached SCSI (SAS) connectors, serial advanced technology attachment (SATA) connectors, drive power connectors, light emitting devices (LEDs), and/or expanders. A typical backplane may further comprise a backplane management device that performs computing, management, and/or support functions for a plurality of drive assemblies. For example, a backplane management device may support four or eight drive assemblies and conduct LED control functions and enclosure management functions for each drive assembly.

### BRIEF DESCRIPTION OF THE DRAWINGS

Example embodiments are described in the following detailed description and in reference to the drawings, in which:

FIG. 1 is a block diagram of a distributed management system in accordance with embodiments;

FIG. 2 is a block diagram of a drive carrier in accordance with embodiments;

FIG. 3 is a graphical representation of a substrate assembly in accordance with embodiments;

FIG. 4 is a graphical representation illustrating how a substrate may be affixed to a drive carrier in accordance with embodiments; and

FIG. 5 is a block diagram showing a non-transitory, computer-readable medium having computer-executable instructions stored thereon in accordance with embodiments.

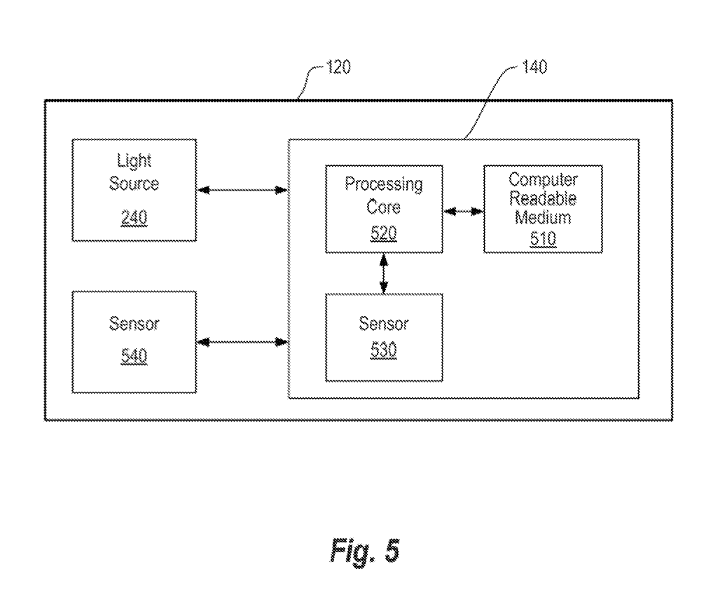

### DETAILED DESCRIPTION

Disclosed are embodiments for a backplane distributed management solution that provides advanced adaptability, serviceability, and fault isolation functions. More specifically, embodiments distribute management functionality normally conducted by a single backplane management device located on the backplane to individual computing devices located on each drive assembly. As a result of this disbursement, advanced adaptability, serviceability, and fault isolation functions are provided, as well as a number of novel and unforeseen functions provided by the computing device on each drive assembly.

Typical storage chassis designs utilize a backplane management device located on the backplane to perform various management functions for a plurality of drive assemblies. The backplane management device may take the form of a single computing device, such as a microprocessor, a complex programmable logic device (CPLD), or an application-specific integrated circuit (ASIC) communicatively coupled to multiple drives via a communication channel. The backplane management device may receive signals from a host device and conduct functions based on the received signals. For example, the backplane management device may receive signals from a host bus adapter (HBA) and drive LEDs to indicate the status of the drive assemblies controlled by the management device. Additionally, the backplane management device may sense conditions and report the sensed conditions to the host device or conduct functions based on the sensed conditions. The backplane management device typically services four to eight drive assemblies and may be cascaded with other backplane management device to support additional drive assemblies (e.g., 32 drive assemblies may be supported by 4 cascaded backplane management devices on the backplane). Hence, a backplane management device serves as a common management node for a plurality of drive assemblies.

The common node approach, however, has a number of significant drawbacks. For example, because multiple drives assemblies are coupled to a single backplane management device, if the backplane management device fails, backplane management services are discontinued for each associated drive assembly. Moreover, because the backplane management device is located on the backplane, if the backplane management device requires servicing, power must be discontinued to the backplane, which necessarily impacts operation of the entire storage chassis. Furthermore, because a single backplane management device is servicing multiple drives assemblies, each associated drive assembly must have common features to enable compatibility with the backplane management device. This effectively limits the ability to use drive assemblies with different feature sets.

Embodiments described herein address at least the above by distributing at least backplane management functionality to the drive assemblies. In some embodiments, the functionality is distributed to a computing device located on a drive carrier of the drive assembly (a portion of the drive assembly typically comprised of only mechanical parts). Further, in some embodiments, communication to the computing device is accomplished via a communication channel distinct from the SAS/SATA communication path which typically couples the backplane to the drive and communicates read/write data therebetween.

For example, in some embodiments, a distributed management system is provided. The distributed management system comprises a backplane and e plurality of drive assemblies communicatively coupled to the backplane via a communication channel. Each of the drive assemblies includes a computing device, and each computing device is configured to provide drive environmental data and control a light source. In some embodiments, each computing device is located on a substrate affixed to a drive carrier of the drive assembly. This distributed arrangement may provide advanced adaptability, serviceability, and fault isolation options. For example, if a computing device associated with one drive assembly fails, the failure will not impact the operation of neighboring drive assemblies because each drive assembly has its own computing device. Additionally, the computing device may be individually serviced by simply removing a single hot-pluggable drive assembly as opposed to powering-off the backplane. Furthermore, the distributed approach allows different types of computing devices with different features to coexist on the same communication channel because strict compatibility with a single backplane management device on the backplane is not necessary.

Further embodiments are also directed to a distributed management system. The distributed management system comprises a backplane and a plurality of drive assemblies communicatively coupled to the backplane via a communication channel. Each drive assembly comprises a computing device. If the computing device of one of the plurality of drive assemblies fails, the computing device of the other of the plurality of drive assemblies continues to operate. Also, if one of the plurality of drive assemblies is removed, the backplane and the other of the plurality of drive assemblies continue to operate.

Additional embodiments are directed to a drive carrier for use in the distributed management system. The drive carrier comprises a substrate, a light source located on the substrate, and a computing device located on the substrate and communicatively coupled to the light source. The computing device is configured to provide environmental data and further configured to control the light source. In addition, the computing device 140 is configured to provide drive assembly location information and/or bay presence information.

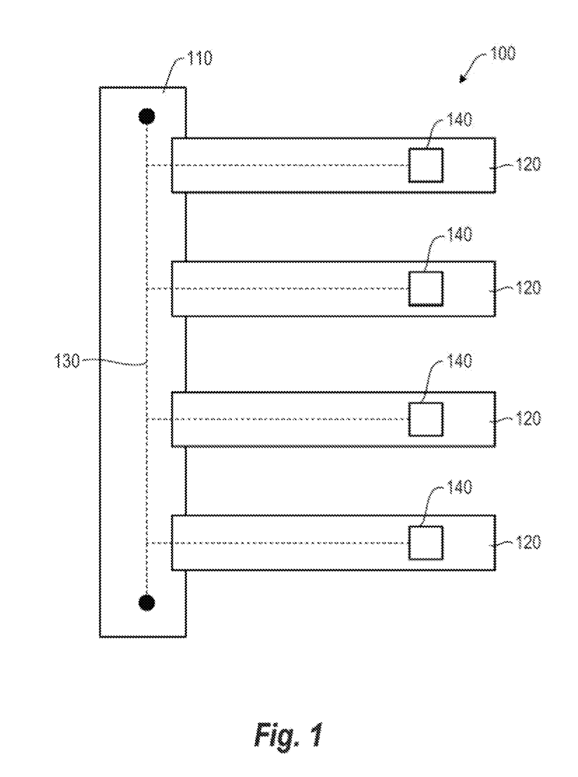

FIG. 1 is a block diagram of a distributed management system 100 in accordance with embodiments. The system 100 comprises a backplane 110 and a plurality of drive assemblies 120. A computing device 140 is located on each drive assembly 120, and a communication channel 130 may communicatively couple the backplane 110 and the computing device 140. The communication channel 130 may be distinct from the SAS/SATA communication channel used to communicate read/write data to/from the drive. The backplane 110 and drive assemblies 120 may be located within a storage chassis, cage, disk enclosure, disk array, and/or server.

The backplane 110 may be a circuit board containing sockets and/or slots into which hot pluggable drive assemblies 120 may be inserted into. Pins and/or connectors may be used on the backplane 110 to pass signals directly to the drive assemblies 120. Additional connectors may be included on the backplane 110 to connect the backplane 110 to a host device (e.g., an array controller, a host bus adapter (HBA), an expander, and/or a server). The host device may communicate with the backplane 110 via a communication bus such as, for example, an inter-integrated circuit (I2C) communication bus or a serial general purpose input/output (SGPIO) communication bus. The backplane 110 may communicate with the drive assemblies via one or more communication busses (e.g., I2C, SAS, SATA, etc.). In embodiments, the backplane 110 may communication with the drive via a first communication channel (e.g., a SAS/SATA bus) and with the computing device 140 via a second communication channel (e.g., an I2C bus). The first and second communication channels may be isolated from one another in accordance with embodiments. The backplane 110 may further comprise power circuitry to provide power to the drive assemblies 120.

Each drive assembly 120 may comprise an drive, a drive carrier, and/or an interposer board (not shown). Each drive assembly 120 may further comprise e computing device 140. In embodiments, the computing device 140 may be located on the drive, the drive carrier, or the interposer board. The drive carrier, as discussed in greater detail below, may be a partial enclosure or casing for the drive, and may be constructed of plastic, metal, and/or other materials. The drive may be, for example, a hard disk drive (HDD), a solid state drive (SSD), or a hybrid drive. The interposer board may be a board with electronics disposed thereon located between, e.g., the drive and the backplane.

The computing device 140 may be, for example, a microcontroller, a microprocessor, a processor, a CPLD, an ASIC, or another similar computing device. As mentioned, it may be located on the drive, the drive carrier, or an interposer board in accordance with embodiments. The computing device 140 may be configured, via instructions stored thereon, to conduct various functions. For example, the computing device 140 may drive various display devices such as LEDs, seven segments, electronic visual displays, flat panel displays, liquid crystal displays (LCDs), touch screens, or the like. The computing device 140 may drive these displays via signals received from the host, signals received from the drive, and/or based on sensed conditions. In some embodiments, the computing device 140 may drive the display devices to illuminate an air flow area, to illuminate a drive not remove indication, and/or to illuminate a self-describing animated image. In some embodiments, the display devices may be part of the drive carrier.

Each computing device 140 may be further configured to provide drive environmental data. In embodiments, the computing device 140 may be communicatively coupled to one or more external sensors (e.g., a temperature sensor, a vibration sensor, a touch sensor, an airflow sensor, a humidity sensor, etc.) or have integrated sensors. The computing device 120 may receive measurements from the sensor(s) and, based thereon, provide environmental data to other devices (e.g., a host device). The computing device 120 may further store the environmental data internally and/or externally. The environmental data may comprise information such as a measured temperature, a measured airflow amount, a measured vibration, and/or a measured humidity. In some embodiments, the computing device 140 may be coupled to a touch sensor (e.g., a capacitive touch sensor or inductive touch sensor) or to a push button. The computing device 140 may be configured to determine when the touch sensor or button has been touched/depressed and conduct functions based thereon, such as providing information about the touch to a host device.

In embodiments, the computing device 120 may “originate” or “source” environmental information. That is, the computing device 120 may be the originator or source of the environmental data rather than a device that acts as a conduit or repeater of such information for another device (e.g., a backplane management device). For example, the computing device 140 may be the originator of temperature information, airflow information, or touch information based on sensor measurements.

Each computing device 140 may be further configured to determine, receive, and/or provide location information. For example, the computing device may be configured to determine, receive, and/or provide bay number and/or box number information. In addition, the computing device may be configured to provide sideband drive installation information. This sideband drive installation information may be helpful for a host device to determine that a drive is installed if the drive failed to linkup at install.

A communication channel 130 may communicatively couple the plurality of drive assemblies 120 and the backplane 110. In embodiments, the communication channel 130 may be a multi-drop communication channel such as an I2C communication bus configured to communicate with the computing devices 140 on the drive assemblies 120. The communication channel 130 may also be a single wire communication bus, a parallel communication bus, or a serial communication bus in accordance with embodiments. This communication channel 130 may be separate or distinct from a SAS/SATA communication channel interconnecting a drive of the drive assembly 120 and the backplane 110.

The above-described arrangement of FIG. 1 may provide a distributed hard drive bay management solution which uses a multi-drop communication channel such as an I2C communication bus to communicate with multiple computing devices 140 located inside drive assemblies 120. This distributed arrangement may overcome disadvantages associated with backplane management devices located on the backplane because, if the above-discussed computing device 140 fails, it will not impact the operation of neighboring drive assemblies (since each drive assembly has its own computing device 140). Additionally, unlike previous designs, the computing device 140 may be individually serviced without powering off the backplane 110 (since it is part of a hot-pluggable drive assembly 120). Still further, the distributed model may allow different types of computing devices 140 which support different drive assembly features to co exist on the same communication channel. Moreover, the distributed model may allow a host (e.g., an array controller, HBA, or expander) to update firmware of the computing device 140 and learn backplane capabilities without relying upon an integrated lights-out (ILO) device to fetch the data across the power supply cable, as is commonly the case with previous designs. Hence, the distributed model MOWS for at least better fault isolation and serviceability of failed computing devices 140, as well as support for a non-homogenous set of drive assembly features within the same storage enclosure.

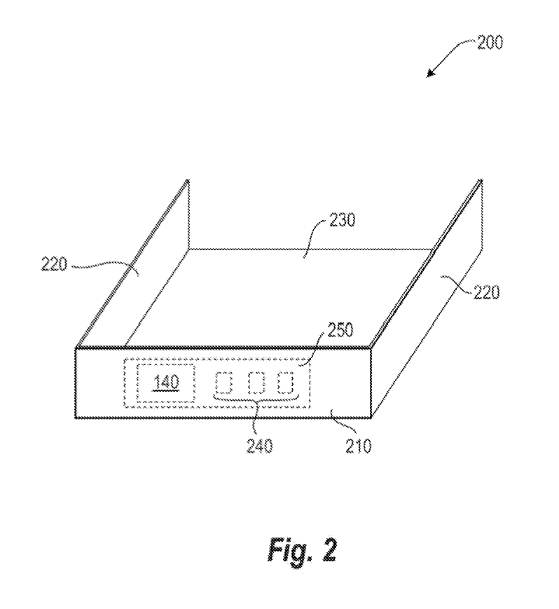

FIG. 2 is a block diagram of a drive carrier 200 in accordance with embodiments. The drive carrier 200 may form a portion of one of the drive carrier assemblies 120 referenced in FIG. 1, and may comprise a substrate 250 with the computing device 140 referenced in FIG. 1 located on the substrate 250. Also located on the substrate 250 may be one or more light sources 240. Accordingly, the drive carrier 200 of FIG. 2 may include components and functionality far beyond the typical “dumb” drive carrier with solely mechanical attributes.

The drive carrier 200 may be constructed of plastic, metal, and/or other materials. It may include a front plate or bezel 210, opposing sidewalls 220, and a floor 230. A drive (not shown), such as a hard disk drive (HDD), solid state drive (SSD), or hybrid drive, may be placed within and/or attached to the area formed by the opposing sidewalls 220, floor 230, and front plate 210. The HDD may use spinning disks and movable read/write heads. The SSD may use solid state memory to store persistent data, and use microchips to retain data in non-volatile memory chips. The hybrid drive may combine features of the HDD and SSD into one unit containing a large HDD with a smaller SSD cache to improve performance of frequently accessed files. Other types of drives such as flash-based SSDs, enterprise flash drives (EFDs), and the like may also be used with the drive carrier 200.

A computing device 140 and one or more light sources 240 may be located on a substrate 250 affixed to the drive carrier 200. The substrate 180 may be for example, a rigid or flexible printed circuit board (PBC). The computing device 140 may be, for example, a microcontroller, a microprocessor, a processor, a CPLD, an ASIC, or another similar computing device. The computing device 140 may be communicatively coupled to one or more light sources 240, and control each in the manner described above. Furthermore, the computing device 120 may have one or more internal sensors or may be communicatively coupled to one or more external sensors (not shown) and receive measurements from each sensor. The computing device 140 may then process and provide the environmental data to other devices (e.g., to a host device). The environmental data may comprise information such as a measured temperature, a measured airflow amount, a measured vibration, and/or a measured humidity. In some embodiments, the computing device 140 may further be coupled to a touch sensor (e.g., a capacitive touch sensor or an inductive touch sensor) or push button. The computing device 140 may be configured to determine when the touch sensor or button has beer touched/depressed and conduct functions such as providing information about the tooth to a host device. The host device may be, for example, a disk array controller, RAID controller, disk controller, a host bus adapter, an expander, end/or a server. The computing device 140 may communicate with the host device via a communication channel such as an I2C communication bus. This communication channel may be separate from the SAS/SATA fabric communicatively computing the host device and a drive of the drive assembly.

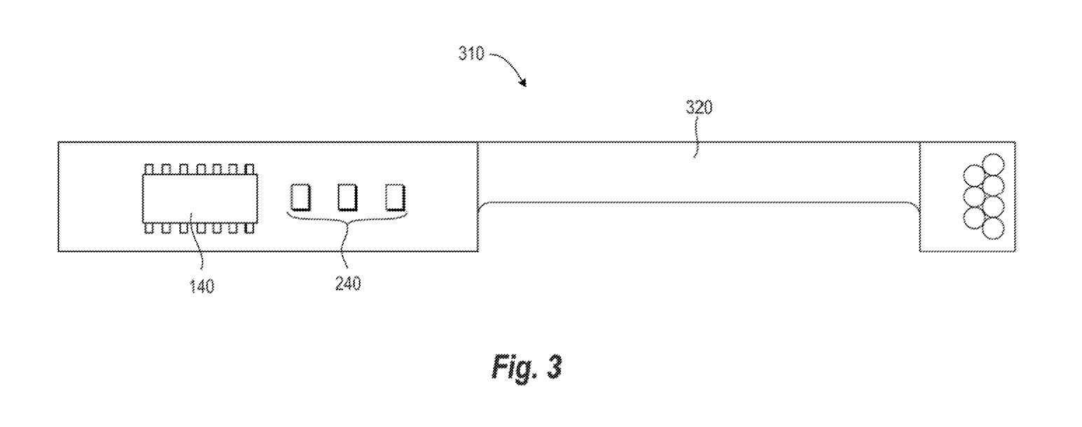

FIG. 3 is a graphical representation of a substrate assembly 250 in accordance with embodiments. In particular, FIG. 3 depicts a flexible printed circuit board 320 with a computing device 140 and multiple light sources 240 located thereon. As described above, the computing device 140 may be communicatively coupled to the backplane via an electrical interface comprising a communication channel (e.g., an I2C communication channel), and may be configured to manage drive environmental data (e.g., temperature information, air flow information, vibration information, and/or touch information), control displays (e.g., LEDs, seven segments, and/or LCDs), report location (e.g., bay and/or box number), and/or provide sideband drive installation information.

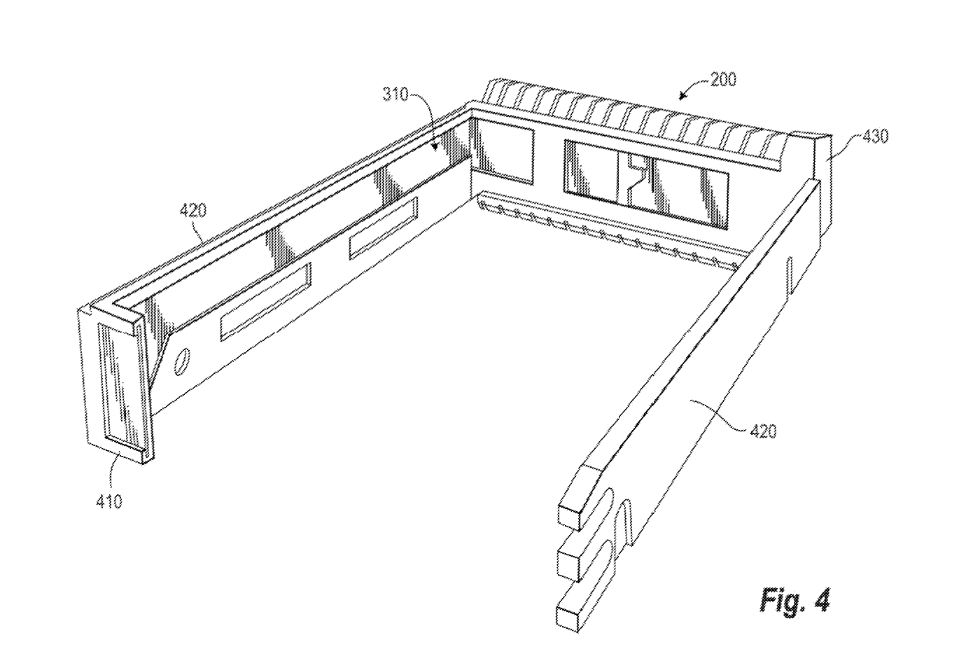

FIG. 4 is a graphical representation of how the substrate assembly 310 of FIG. 3 may be affixed to the drive carder 200 in accordance with embodiments. As shown, the substrate assembly may utilize as flexible printed circuit board and be coupled to the rear of the drive carrier 410, one of the opposing sidewalls 420, and the front of the drive carrier 430. Of course, alternate configurations may also be used in accordance with embodiments. For example, in embodiments, a rigid printed circuit board may be affixed to the rear of the drive carrier 410, one of the opposing sides 420, and/or the front of the drive carrier 430.

FIG. 6 is a block diagram showing a non-transitory, computer-readable medium having computer-executable instructions stored thereon in accordance with embodiments. The non-transitory, computer-readable medium is generally referred to by the reference number 510 and may be included in computing device 140 of drive assembly 120 described in relation to FIG. 1. The non-transitory computer-readable medium 510 may correspond to any typical storage device that stores computer-implemented instructions, such as programming code or the like. For example, the non-transitory computer-readable medium 510 may include one or more of a non-volatile memory, a volatile memory, and/or one or more storage devices. Examples of non volatile memory include, but are not limited to, electronically erasable programmable reed only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. A processing core 520 generally retrieves and executes the instructions stored in the non-transitory, computer readable medium 510 to operate the computing device 140 in accordance with embodiments.

In some embodiments, the instructions, upon execution, may cause the computing device 140 to control a light source 240 to illuminate an air flow area, illuminate a drive not remove indication, and/or illuminate a self-describing animated image. For example, the computing device 140 may control the light source 240 to substantially illuminate an air flow and/or air vent area. This illumination may be used in conjunction with a drive locate feature to make it easier to identify a drive assembly within a chassis full of drives assemblies, and thereby ease the burden on on-site technicians trying to locate a drive among a sea of similar drives. The computing device 140 may additionally control the light source 240 to, for example, produce a self-describing animated image. This may be accomplished by turning on and off the plurality of light sources 240 in a predetermined or predeterminable sequence. In one example, the multiple light sources 240 may be arranged in a circle or ring configuration. The computing device 140 may turn on/off the light sources 240 to produce an animated image of a spinning disk or hard drive activity. Moreover, the computing device 140 may turn on/off the light at a particular rate to give the appearance of varied intensity/brightness. This animated image of a spinning disk may be activated when for example, the computing device 140 determines that an associated HDD has an outstanding command. The computing device 140 may further control the light source 240 to for example, illuminate a do not remove indication. The do not remove indication may be part of an eject button and may be created via an in-mold decorating process. More specifically, in an example, the computing device 140 may control a light source 240 inside a hard drive carrier eject button such that an icon is illuminated to inform a viewer that ejecting the drive will result in a logical drive failure. A user, therefore, has instant knowledge and confidence that a drive is safe to remove. As a result, self-inflicted logical drive failures may be reduced. Moreover, removal of a drive against an administrator's wishes or in violation of another rule may be reduced.

In further embodiments, the instructions, upon execution, may cause the computing device 140 to receive measurements from internal sensors 530 or external sensors 540. In some embodiments, a sensor may be a touch sensor and the computing device 140 may determine based on a sensor measurement if the sensor has been touched. In response to a determination that the sensor has been touched, the computing device 140 may conduct a process such as outputting from the computing device a signal indicating that the sensor has been touched, issuing a command to create a default logical drive, changing or toggling device definitions, and/or providing an early drive removal indication to another device. In further embodiments, the sensor may be a temperature sensor, a vibration sensor, a touch sensor, an airflow sensor, and/or a humidity sensor. The computing device 140 may receive measurements from the sensor and provide/store environmental data based on the measurements. The environmental data may comprise information such as a measured temperature, a measured airflow amount, a measured vibration and/or a measured humidity.

In still further embodiments, the instructions, upon execution, may cause the computing device 140 to determine, receive, store, and/or provide location information about the associated drive assembly 120. This information may comprise, for example, a bay number and/or box number. The instructions may further cause the computing device to provide sideband drive installation information to a host device. This sideband drive installation information may be helpful for a host device to determine that a drive is installed if the drive failed to linkup at install.

The above-described embodiments present a novel and unforeseen backplane distributed management solution which provides advanced adaptability, serviceability, and fault isolation functions. More specifically, embodiments distribute management functionality typically conducted by a backplane management device to a computing device located on the drive assembly and, as a result provide the advanced adaptability, serviceability, and fault isolation features. Furthermore, the computing device 140 on the drive assembly conducts novel and unforeseen functions outside the scope of backplane management devices.

As described, some embodiments may utilize a multi-drop communication channel such as an I2C communication bus to communicate with multiple computing devices 140 located inside drive carriers. This distributed arrangement may overcome disadvantages associated with earlier designs because, if a computing device 140 fails, it will not impact the operation of a neighboring drive. Additionally, unlike previous designs, the computing device 140 may be individually serviced without powering-off the backplane 110 because it is part of a hot-pluggable drive assembly. Still further, the distributed model may allow different types of computing devices 140 which support different drive assembly features to co-exist on the same communication channel. For example, one computing device 140 on a drive assembly 120 may support a touch sensing feature while another neighboring computing device 140 on a drive assembly 120 may not support such a feature. Likewise, one computing device 140 on a drive assembly 120 may support advanced display features while another neighboring computing device 140 on a drive assembly 120 may not support such features. The distributed model, accordingly, allows for at least better fault isolation and serviceability of failed computing devices 140, as well as support for a non-homogenous set of drive assembly features within the same storage enclosure.

What is claimed is:

1. A distributed management system, comprising:
a backplane; and
a plurality of drive assemblies communicatively coupled to the backplane via a communication channel,
wherein each of the plurality of drive assemblies includes a computing device, and
wherein each of the computing devices is to provide drive environmental data and control a light source.

2. The system of claim 1, wherein each of the computing devices is located on a substrate affixed to a drive carrier of each of the plurality of drive assemblies.

3. The system of claim 1, wherein each of the computing devices does not include the same feature set.

4. The system of claim 1, wherein, if the computing device of one of the plurality of drive assemblies fails, the computing device of the other of the plurality of drive assemblies continues to operate.

5. The system of claim 1, wherein, if one of the plurality of drive assemblies is removed, the backplane and the other of the plurality of drive assemblies continue to operate.

6. The system of claim 1, wherein each of the computing devices is further to provide drive assembly location information.

7. The system of claim 1, wherein each of the computing devices is further to provide bay presence information.

8. The system of claim 1, wherein the environmental data comprises measured temperature information, measured airflow information, or measured vibration information.

9. A distributed management system, comprising:
a backplane; and
a plurality of drive assemblies communicatively coupled to the backplane via a communication channel,
wherein each of the plurality of drive assemblies includes a computing device,
wherein, if the computing device of one of the plurality of drive assemblies fails, the computing device of the other of the plurality of drive assemblies continues to operate, and
wherein, if one of the plurality of drive assemblies is removed, the backplane and the other of the plurality of drive assemblies continue to operate.

10. The system of claim 9, wherein each of the computing devices does not include the same feature set.

11. The system of claim 9, wherein each of the computing devices is to provide drive environmental data and control a light source

12. A drive carrier for use in distributed management system, the drive carrier comprising:
a substrate;
a light source located on the substrate; and
a computing device located on the substrate and communicatively coupled to the light source,
wherein the computing device is to provide drive environmental data and control the light source.

13. The drive carrier of claim 12, wherein the environmental data comprises measured temperature information, measured airflow information, or measured vibration information.

14. The drive carrier of claim 12, wherein computing device is further to provide assembly location information.

15. The drive carrier of claim 12, wherein the computing device is further to provide bay presence information.
